(19) United States
(12) Patent Application Publication
(10) Pub. No.: US 2025/0069013 A1
(43) Pub. Date: Feb. 27, 2025

(54) RISK SCORING OF EMPLOYEE COMMUNICATIONS USING UNAUTHORIZED COMMUNICATIONS CHANNELS

(71) Applicant: Bank of America Corporation, Charlotte, NC (US)

(72) Inventors: Vinesh Patel, London (GB); Michael Young, Davidson, NC (US); Tanvi Patel, London (GB)

(21) Appl. No.: 18/237,936

(22) Filed: Aug. 25, 2023

(51) Int. Cl. G06Q 10/0635; G06Q 30/018

(52) U.S. Cl. CPC G06Q 10/0635; G06Q 30/018

(57) ABSTRACT

A system may be used by an entity to determine and reduce risks that may result from employees communicating with clients or others using unauthorized communications channels. The system may monitor communications over authorized communication channels or obtain notifications from a monitoring system for explicit or implicit references to the use by employees of unauthorized communications channels. An AI/ML scoring engine may generate a communication-specific risk score that may be used to understand the degree of risk posed by the communication. The scoring engine may also generate an employee specific risk score that accounts for employee specific risk-related factors that may affect the risk associated with the communication. The risk scoring may be used to cause automated risk reduction operations to be performed, such as providing alerts to an employer or employee of risk issues or halting trading or communications by the employee.

### FIELD OF THE DISCLOSURE

Aspects of the disclosure relate to reducing an employer's risk that may result from employees using unauthorized communications channels to conduct business.

### BACKGROUND OF THE DISCLOSURE

Businesses may require that business-related communications between certain employees and other parties, such as clients or other employees, be conducted only over authorized communications channels. The authorized communications channels may be monitored to ensure compliance with regulatory and business requirements. Non-compliance with government requirements may result in regulatory action such as fines. Authorized communications channels may include, for example, communications over a work email account, telephone, video conferencing, chat system, text messaging, instant messaging, or direct messaging. Employees who are restricted to using authorized communications channels may not use unauthorized communications channels, which may be non-regulated, for business-related matters, such as for discussing or conducting business. The unauthorized communications channels may include alternative communications channels that may be prohibited from use by certain employees by law or regulation. Unauthorized communication channels may include communication channels that may not be authorized for use by the employees to conduct business-related communications, such as, for example, social media, personal emails, calls from a personal telephone, a chat service, text messaging, instant messaging, or direct messaging. The alternative communications channels may not be monitored or recorded.

Businesses may make efforts to monitor for employee use of unauthorized communications channels. For example, authorized communications channels may be monitored for a list of predetermined words or phrases during communications that may be used to identify uses of unauthorized communications channels. For communications that are unauthorized as they are conducted over the unauthorized communications channels, there is no mechanism to quantify for the business the per-communication or cumulative risk that it may have from such communications, or to quantify the risk that may be caused by some employees.

It would be desirable for a business to better understand the scope of the risks that may be presented by the unauthorized communications of its employees at one or more points in time, and to use the information to mitigate the risks and to comply with government regulations.

### SUMMARY OF THE DISCLOSURE

It is an object of this invention to generate, using artificial intelligence (AI)/machine learning (ML), risk scores associated with uses of unauthorized communications channels by employees conducting business matters and to use the risk scores to enable automated operations to reduce future risk based on the risk scores.

An AI communications risk reduction system may be provided in accordance with the present disclosure. The system may be implemented by an entity for reducing risk to an entity caused by employees of the entity communicating with one or more other parties using unauthorized communications channels. The entity may be a business, such as a financial institution, that employs employees. The risk may include a regulatory risk.

The system may include a monitoring engine that is configured to monitor one or more authorized communications channels and detect references in communications that use the one or more authorized communications channels to uses of unauthorized communications channels by the employees to communicate with the one or more other parties. The authorized communications channels may include a first group (one or more) of communications channels that the entity may allow the employees to use for entity-related (e.g., business-related) communications. The unauthorized communications channels may include a second group (one or more) of communications channels that the entity does not allow the employees to use for entity-related communications. Unauthorized communications channels may include an unauthorized email account, a personal employee telephone, a text, a chat service, an instant messaging service, or social media.

The system may include a scoring engine that is configured to use AI/ML to generate, for each of a plurality of the communications that includes one of the detected references, a first risk score for a respective one of the communications. The first risk score may be based on one or more first risk-related factors that are related to the respective one of the communications and may be identified by the scoring engine for risk scoring of unauthorized communications channels usage. The one or more first risk-related factors may include predetermined factors. The scoring engine may be configured to generate a second risk score for the respective one of the communications. The second risk score may be based on one or more second risk-related factors that relate to employee specific information that is specific to a respective one of the employees who engaged in the respective one of the communications. The first risk-related factors and the second risk-related factors may be different, or one or more of the first risk-related factors may overlap with the one or more second risk-related factors.

The system may be configured to cause an operation to be performed to reduce risk when the first risk score or the second risk score is at a predetermined risk level or is within a predetermined risk score range.

The scoring engine may be configured to use behavioral analytics to generate the first risk score or the second risk score. The scoring engine may be configured to use sentiment analysis to generate the first risk score or the second risk score.

The one or more first factors may include one or more of a type of the respective one of the unauthorized communications channels that has been referenced, a first risk history at the entity for the type of the respective one of the unauthorized communications channels, a previous escalation for the type of the respective one of the unauthorized communications channels, a participant count (i.e., the number of parties who participate in the authorized communication), or the one or more other participants. One or both of the first risk score and the second risk score that are generated may be based on one or more of a time of day, a day of a week, month or year, or a reporting cycle for the entity.

The employee specific information for the second risk-related factors may include one or more of a job title, a job description, job responsibilities, a job location, years of service, seniority, a regulated status of the respective employee at the entity, employee access to confidential information, or a history of interactions by the respective employee with the one or more other participants.

The first risk score may be based in part on the employee specific information. The second risk score may be based in part on the first risk score.

The operation may include one or more of sending an alert to the respective employee or to a manager of the employee, halting a trade that was arranged by the respective employee, blocking further communications by the respective employee, or sending a reminder to the respective employee about a policy of the entity regarding use of unauthorized communications channels. The operation may include triggering an investigation by the entity of the unauthorized communication that may be triggered based on the first risk score and the second risk score.

The first risk score or the second risk score may be generated, for example, using the following formula:

$$0 \leq \sum {W}_{i} {f}_{i} \leq X for i = 0 to n$$

where fᵢ is the value of the iₜₕ risk factor that represents the risk determined for the risk factor, Wᵢ is the weight given to the risk factor, Wᵢfᵢ is the value of the weight Wᵢ multiplied by the value fᵢ, ΣWᵢfᵢ for i=0 to n is the calculated value of the respective risk score, and X is a maximum risk score for the first risk score or the second risk score. In embodiments, X may equal 100 such that the first risk score or the second risk score may be a value that ranges between 0 and 100.

The one or more other parties with which the employee may engage in communications may include an individual at the entity that is unauthorized to receive certain information to which the employee has access or an individual not employed by the entity.

A risk reduction computer program product for using AI may be provided in accordance with the present disclosure to reduce risks to an entity caused by employees of the entity communicating with one or more other parties using unauthorized communications channels. The computer program product may include executable instructions that, when executed by a processor on a first computer system, monitor one or more authorized communications channels and detect references to uses of one or more unauthorized communications channels by the employees to communicate with the one or more other parties.

The executable instructions may generate, for each of a plurality of the communication that include one of the detected references, using AI/ML, a first risk score based on one or more first risk-related factors. The one or more first risk-related factors may be identified by the scoring engine for risk scoring of unauthorized communications channels usage. The one or more first risk-related factors may include predetermined factors. The executable instructions may generate, for a plurality of the detected references, a second risk score corresponding to a respective one of the employees that made the respective one of the references. The second risk score may be based on one or more second risk-related factors that relate to employee specific information that is specific to a respective one of the employees who engaged in the respective one of the communications. The executable instructions may cause an operation to be performed to reduce risk when the first risk score or the second risk score is at a predetermined risk level or is within a predetermined risk score range.

The first risk score or the second risk score may be generated using one or both of behavioral analytics or sentiment analysis. The first risk score may be based on one or more of a type of the respective one of the unauthorized communications channels that has been referenced, a first risk history at the entity for the type of the respective one of the unauthorized communications channels, a previous escalation for the type of the respective one of the unauthorized communications channels, a participant count for an authorized communication in which use of the respective unauthorized communication is referenced, or the one or more other participants. One or both of the first risk score and the second risk score that are generated may be based on one or more of a time of day, a day of a week, month or year, or a reporting cycle for the entity.

The operation may include one or more of sending an alert to the respective employee or to a manager of the employee, halting a trade that was arranged by the respective employee, blocking further communications by the respective employee, or sending a reminder to the respective employee about a policy of the entity regarding use of unauthorized communications channels.

The employee specific information for the second risk-related factors may include one or more of a job title, a job description, job responsibilities, a job location, years of service, seniority, a regulated status of the respective employee at the entity, employee access to confidential information, or a history of interactions by the respective employee with the one or more other participants.

One or more of the unauthorized communications channels may include one of an unauthorized email account, a personal employee telephone, a text, a chat service, an instant messaging service, or social media.

An AI communications risk reduction system may be provided in accordance with the present disclosure for reducing risks to an entity caused by employees of the entity communicating with one or more other parties using unauthorized communications channels. The system may include an input for receiving electronic alerts to detections of references to uses of one or more of unauthorized communications channels by a respective one of the employees to communicate with the one or more other parties. The authorized communications channels may include a first group of communications channels that the entity allows the employees to use for entity-related communications. The unauthorized communications channels may include a second group of communications channels that the entity does not allow the employees to use for entity-related communications. The electronic alerts may be generated by a monitoring system that monitors for communications by employees that reference usage of unauthorized communications channels.

The system may include a scoring engine that uses AI/ML to generate, for each of a plurality of the communications that includes one of the detected references: a first risk score based on one or more first risk-related factors for risk scoring of unauthorized communications. The one or more first risk-related factors may be identified by the scoring engine for risk scoring of unauthorized communications. The one or more first risk-related factors may include predetermined factors. The scoring engine may generate, for the one or more of the detected references, a second risk score that corresponds to a respective one of the employees that made the respective one of the detected references. The second risk score may be based on one or more second risk-related factors that reflect employee specific information for the respective employee.

The system may be configured to cause an operation to be performed to reduce risk when the first risk score or the second risk score is at a predetermined risk level or is within a predetermined risk score range.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative risk scoring system for reducing employee use of unauthorized communications channels in accordance with principles of the disclosure.

FIG. 4 shows an illustrative list of factors for risk scoring in accordance with principles of the disclosure.

FIG. 5 shows illustrative examples of communication-specific and employee specific risk scoring in accordance with principles of the disclosure.

FIG. 6A shows illustrative factors that may increase risk scores in accordance with principles of the disclosure.

FIG. 6B shows illustrative factors that may decrease risk scores in accordance with principles of the disclosure.

FIG. 7 shows an illustrative example of a flow chart of factors for risk scoring in accordance with principles of the disclosure.

FIG. 8 shows an illustrative system in accordance with principles of the disclosure.

### DETAILED DESCRIPTION OF THE DISCLOSURE

The present disclosure relates to systems, computer program products, methods, and apparatus for reducing risks associated with employees of an entity, such as a business, a non-profit, a governmental agency or another entity, communicating with other parties, such as other employees, clients or third parties, about matters related to the entity using unauthorized communications channels. The term business-related matters is used herein to refer generally to matters related to the entity, such as a business matters in which a business may be engaged. The term unauthorized communications channels is used herein to refer to communications channels that are not authorized by the employer for use by the employees to discuss business-related matters. The unauthorized communications channels may also be referred to “alternative communications channels.” Communications on these unauthorized communications channels may be deemed unauthorized communications. These channels may be unauthorized for certain communications related to the entity as they may be prohibited for use by law or regulations (“off channel communications”) or because the employer just does not authorize these channels for use for all or some matters related to the entity.

Unauthorized communications may include communications over the unauthorized communications channels between employees at the same entity who are unauthorized to discuss business matters. For example, a financial institution may have a private side and a public side where the two sides are not permitted to discuss business matters. The channels may be unauthorized for employees on the private side because the channels may be unmonitored by the entity.

The system may detect possible use of unauthorized communications channels by monitoring authorized communications channels that are permitted for use by the employees. In embodiments, the monitoring may be performed by the entity using a monitoring engine to detect words or phrases within a communication, patterns, inflections, behaviors, or other data points in monitored communications that directly or indirectly reference the use of an unauthorized communications channel. For example, during a monitored conversation, the employee or another participant in the conversation may say or write “Let's talk this discussion offline” after a reference to a mergers and acquisitions deal. Or an employee may say or write “Let's catch up” and suggest switching to an unauthorized type of communications channel. Monitoring may be performed in real-time. The detection of the use of an unauthorized communications channel may trigger an alert to the employee, employer, or both.

The detection of the use of an unauthorized communications channel may trigger an analysis of a risk associated with the use of the unauthorized communications channel. This analysis may be performed by a scoring engine that may use AI/ML to perform an analysis of the risk that may be caused by the communication. The scoring engine may determine one or more first risk scores for each detected reference, or for fewer than all of the detected references, in a communication over an authorized communications channel to use of an unauthorized communications channel by the employee. The system may also determine a second risk score to an employee who is detected to have engaged in use of an unauthorized communications channel. The risk scores may be numerical scores. The scoring engine may also use behavioral analysis (BA) that analyzes the employee's behavior during the authorized communication or during the one or more references to unauthorized communications to derive the risk scores. The scoring engine may also use sentiment analysis (SA) that analyzes the employee communications for the emotional tone of the communications to derive the risk scores.

The scoring by the scoring engine may be based on factors that may be determined by the scoring engine to best reflect the risk that has historically been associated with certain type of unauthorized communications by employees at the entity under similar circumstances. The factors may include predetermined factors. In embodiments, a first risk score for a detected reference to a use of an unauthorized communications channel may be determined for a single communication and may reflect a risk of that communication. The first risk score may not be generated based on factors that are employee specific, such as details about the employee. In embodiments, a second risk score that is specific to the employee who engaged in the communication may be generated based on details about the employee.

Each of the first and second risk scores determined by the scoring engine may be based on one or more factors that may increase or decrease the risk scores.

The factors used to generate the first risk score for a detected use of an unauthorized communications channel may be based on factors that may be determined by the scoring engine or may be predetermined to best reflect the risk associated with certain type of using the unauthorized communications channels. Some other examples of other factors that may be accounted for in the first risk score are described below.

The second risk score may be based on factors that may be determined by the scoring engine to reflect employee specific factors related to the communication or the risk that has historically been associated with past communications of the employee who engaged in the unauthorized communications, or both. Examples of some additional employee specific factors that may be accounted for in the second risk score are described below.

In embodiments, the second risk score may be based in part on the first risk score for the same communication and may be a modification of the first risk score based on employee specific information. In embodiments, the first risk score may be based in part on the second risk score.

The first and second risk scores may be presented to the entity, e.g., the employer. The first and second risk scores may be presented on a scale, such as from 0 to 100, with a 0 indicating no risk and 100 indicating very high risk. The risk scores may also be correlated to levels of risk, such as low risk, medium risk, and high risk. As an example, a low risk may be correlated to a risk score of 0 to 30, a medium risk may be correlated to a risk score of 31 to 70, and a high risk may be correlated to a risk of 70 to 100. The level of risk may also be displayed, such as in an alert or in a report, as color coded. For example, a high risk may be shown with a red background, a moderate risk may be shown with a yellow background, and a low risk may be shown with a green background.

The risk scoring may be used to determine a cumulative risk to the entity at a point in time based on scores for multiple unauthorized communications by the entity's employees. The cumulative risk may be provided to the entity.

The risk scoring may be used to determine whether to perform an automated operation.

As an example, the value of the first risk score, the second risk score, or both the first and second risk scores for the unauthorized communications may be used to determine whether to send an alert to the respective employee or to a manager of the employee. The alert may inform them that a reference to the use of an unauthorized communications channel was detected. A reminder may be sent to the respective employee about the prohibition of using unauthorized communications channels for business-related matters. That may be sufficient to prevent a further unauthorized communication by the employee.

As another example, if the risk score is in a high range, a trade that may have been arranged by the employee for a party to the unauthorized communication may be halted, or further communications by the respective employee may be blocked.

An investigation by the entity of the employee may also be triggered when a risk score is within a certain level. The operation may be performed by the system or may be caused to be performed by another system. The level of operation that is performed may be elevated based on a recent determination of an average risk score for the entity. If the average risk score is above a threshold, the entity may wish to take more intense efforts to reduce the overall risk from unauthorized communications.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

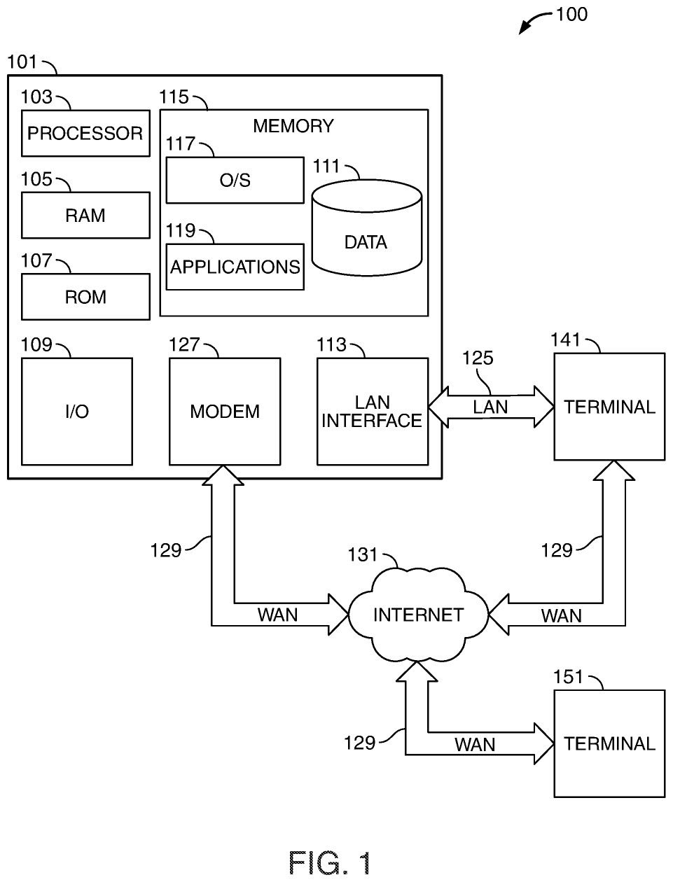

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry ™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

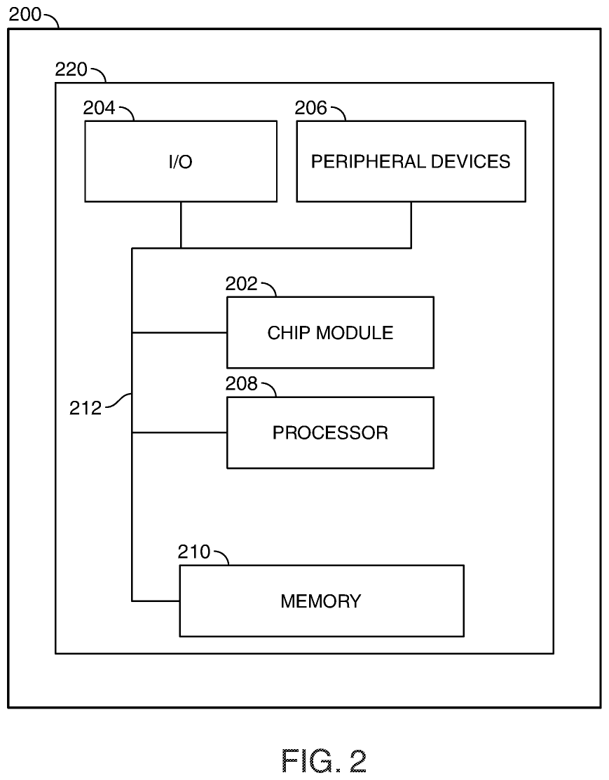

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

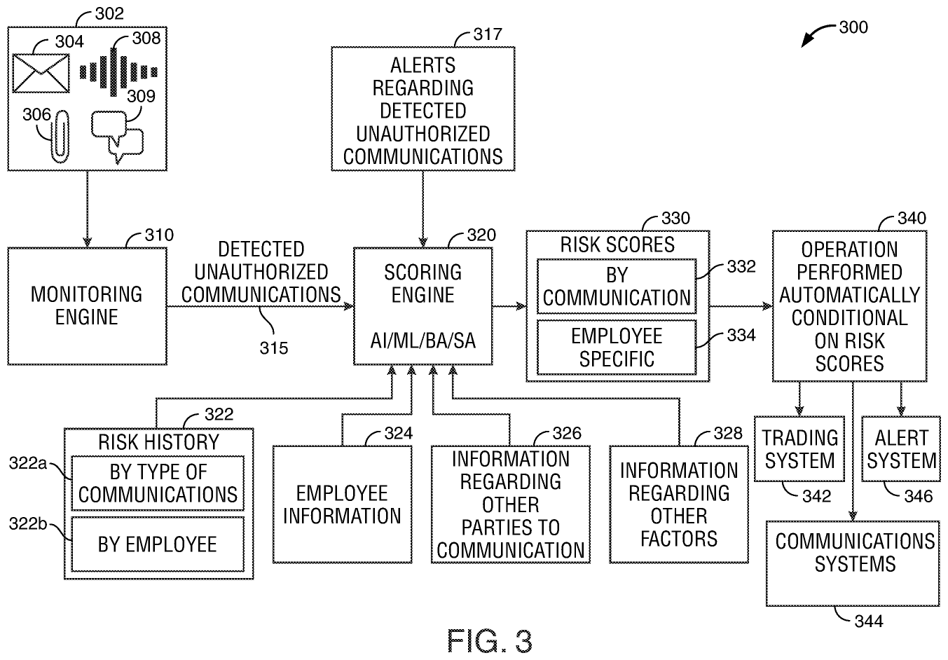

FIG. 3 shows an illustrative AI system 300 for reducing risks associated with employees' use of unauthorized communications channels by scoring risks of unauthorized communications. The type of employee communications 302 with other participants may include, for example, emails 304 (which may include attachments 306), voice communications 308 like phone calls or videoconferences, text messages 309, chats, instant messages, direct messages, or social media (not shown). Some of these types of communications may be authorized by the entity for employee use for certain types of business communications. Other types of communications may not be authorized. The communications channels may be unauthorized for use due to government regulations. For example, the government regulations may require that certain channels be monitored and that communications over other channels, such as alternative communications channels may not be used because they are unmonitored. The communications channels may also be unauthorized for use by employees by the entity for other reasons. Communications may be performed using various user devices, such as a computers, phone, or tablet. While communications of some employees may need to be monitored, other communications of the employees or unregulated communications of some employees may not need to be monitored.

Authorized communications may be monitored by a monitoring engine 310 to detect the use of unauthorized communications channels. Monitoring engine 310 may be operated by the entity or may be operated by a third party. Monitoring engine 310 may determine what to monitor in the authorized communication or to determine whether there was also one or more unauthorized communications over an unauthorized communications channel. In embodiments, monitoring engine 310 may monitor for predetermined words or phrases that may indicate an unauthorized communication. For example, monitoring engine 310 may review an authorized email sent or received by the employee to detect a reference to another communication that may explicitly mention or implicitly suggest use of an unauthorized communications channel.

Detected uses of unauthorized communications channels may be forwarded by monitoring engine 310 for input to a scoring engine 320 for scoring the risk of the detected unauthorized communications. Scoring engine 320 may also be alerted via one or more inputs 317 to other unauthorized communications that may have been detected other than by monitoring engine 310. For example, there may be a monitoring service that monitors some communications channels for the entity. Risk scores for these communications and the employees involved with them may be determined by scoring engine 320.

Scoring engine 320 may calculate one or more numerical risk scores corresponding to detected references to the use of unauthorized communications channels. A first risk score may be a risk score that reflects a risk posed by an employee's communication over an unauthorized communications channel. A second risk score may be a risk score that reflects a risk based on factors specific to this employee.

The risk scores may be based on multiple factors. The factors that are selected as a basis for risk scoring of the first and second risk scores may be selected based on information available to the scoring system. The factors may be selected for consideration using AI/ML. Factors may include factors that are predetermined for use in the calculations of the scores. The risk history for the type of unauthorized communication channel for use as a factor in risk scoring of the first score and the risk history of the employee may be mined for risk-related factors to be selected for calculations of the second risk score.

As an example, the first risk score may be based on the type or contents of communication or a risk history 322a experienced by the entity, or experienced by other entities based on public information, for that type of communication. The second risk score may be calculated based, for example, at least on information 324 about the employee who engaged in the communication, and a risk history 322b for the employee. The second risk score may also be calculated independent of the first risk score or based also on the first risk score.

As another example of calculating a first risk score that is communication specific or a second risk score that is employee specific, scoring engine 320 may first determine which factors will be used in the calculation of a first risk score and a second risk score. For calculating each of the risk scores, each factor may be assigned one of a range of values, where a value may reflect a level of risk. For example, the values may be 1 for low risk, 2 for medium risk, and 3 for high risk. Each factor value f may be multiplied by a weight W whose value (e.g., 1, 2, 3 . . . ) reflects the significance of the factor that may be determined by scoring engine 320. For example, a past historic risk for the type of communication may be given more weight than a time of day of the communication. As another example, the weights for a particular factor may be based on a level of significance placed on the factor by government regulator.

Risk scores, including the first risk score and the second risk score, may be calculated to fall, for example, within a predetermined range. The predetermined range may vary. As one example, one scoring method may be to assign risk scores over a range of 0 to 100. A “0” score may be defined to mean that scoring engine 320 has determined that there is no risk at all for a particular communication and a “100” score may be defined to mean the highest possible risk. In other examples, the predetermined range may be between a range of 0 and 50, or between some other range.

An example of a formula to be used by the scoring engine 320 to calculate the risk scores may be:

$$0 \leq \sum {W}_{i} {f}_{i} \leq X for i = 0 to n$$

where fᵢ is the value of the iₜₕ risk factor that represents the risk determined for the risk factor, Wᵢ is the weight given to the risk factor, Wᵢfᵢ is the value of the weight Wᵢ multiplied by the value fᵢ ΣWᵢfᵢ for i=0 to n is the value of the risk score, and X is a maximum risk score for the first risk score or the second risk score. The first and second risk scores may be established to extend over a desired range of possible risk scores. Where risk is to be scored at a value between 0 and 100, X may be set to 100.

Other scoring alternatives may be used at scoring engine 320. For example, each factor may be given a range where the range may be larger for a factor that is to be given more weight than another factor. In this alternative, the risk values of the factors on which scoring is based may not need to be multiplied by a weight W.

Risk scores may be calculated so that comparable factors are used to compare the risks posed by the communications.

A determination of one or both of the first or second risk scores may at least be based on behavioral analysis (BA) or sentiment analysis (SA) to be performed at scoring engine 320. BA or SA may be used to adjust a value of a factor f, or a weight W to be attributed to the factor f.

The risk scores 330 calculated for a detected unauthorized communication may be output from scoring engine 320 as a first risk score 332 that is communication specific and a second risk score 334 that is employee specific. Risk history 322, employee information 324, information regarding other parties/participants in the communication 326, other information that may be related to risk factors 328, and risk scores 330 may be stored in one or more databases (not shown), such as at a backend of the entity. The risk scores 330 may be added to a stored risk history 322 to be used in scoring future unauthorized communications. Records of the use of unauthorized communications channels by employees, at least those that may present a risk to the entity, may be added to a blockchain for tracking.

The risk scores may be presented to an employer or employee on a display or otherwise as one or more of a numerical value, color codes, or a reference to a level of risk (e.g., low, medium, high). The numerical values may be correlated to the color codes and levels of risk that may be displayed to the employer or employee.

The risk scores 330 may be used at 340, such as by a processor at system 300, to determine whether to cause an operation to reduce risk to be performed automatically at 340. An operation that may be performed automatically in response to one or more scores that indicate a high risk may transmit an instruction to halt or limit the employee's trading activities on a trading system 342. A limit on trading activities may be, for example, a limit on trading certain stocks. Another operation that may be performed is to prevent or limit communications by the employee using employer-provided communications devices or systems 344. Another operation that may be performed may be providing an alert to the employer using an alert system 346, such as by a business email. The alert may provide details of the unauthorized communication that was detected and other available detail, such as the participants in the conversation, as best as may be determined. The alert may also include the risk scores so that the recipient of the alert is not just informed of the risk but also gets a sense of the risk by knowing the risk scores that the scoring engine has assigned. The numerical scores may be provided to the employer as well.

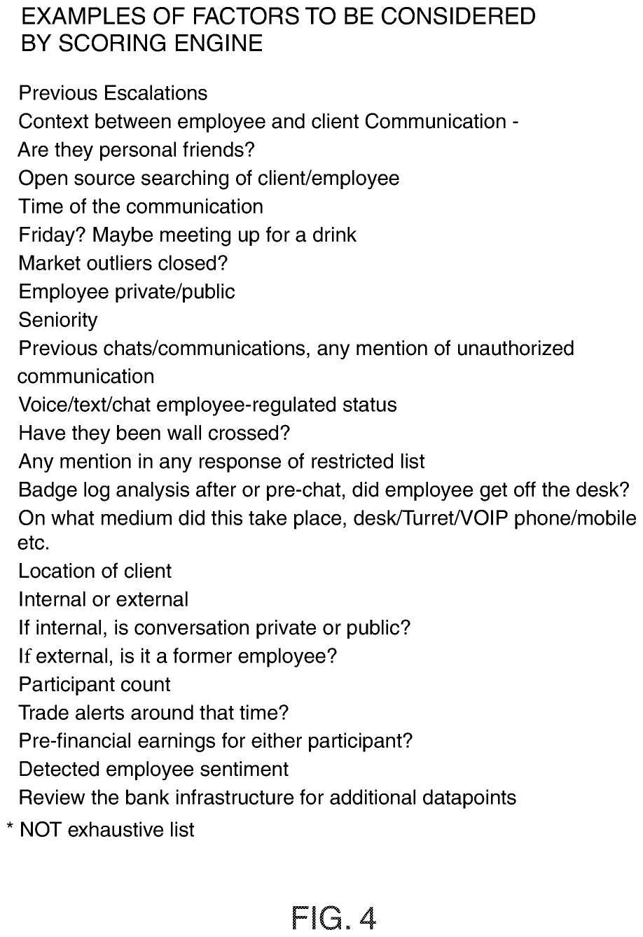

FIG. 4 shows a list of examples of factors that an AI scoring engine may consider in determining the communication-specific and employee specific risk scores. The factors shown in this figure is illustrative, but non-exhaustive. Other factors may be relied upon. These factors may include subfactors to which the risk may be separately allocated and weighted. Some of the factors relied on in calculating the first, communication-specific risk score and the second, employee specific risk score may be the same. Some examples of factors that may be relied on in communication specific risk scoring or employee specific risk scoring or both are identified with an asterisk (*). Factors may include one or more of:

Factors may be related to, for example:
The type or contents of the communication, e.g. a call or a writing, in which the reference to an unauthorized communications channel was detected.
Previous escalations of risk associated with the type of unauthorized communications channel that is referenced.
Searches for historic risk of that type of violation.
Searches for historic risks of an out of hours login, i.e., meaning risk associated with communications during non-working hours, if the communication may have happened out of hours.
Timing of the communication—For example, the timing may include one or more of timing of a call on a particular time of day or a day of the week, or a day of a specific significant market event that may influence the amount of risk considered by the scoring engine. The scoring engine may assign a different risk value depending on a day of the week of a communication. As an example, a communication on Friday, at the end of the work week, may be more likely to reflect a permitted social call, such as to meet for a drink, rather than a business call. Thus, a communication on Friday may be assigned a lower risk value.
A communication regarding trades related to a market outlier, if trade related. A market outlier business may have sales that are much higher or much lower than an average business. The scoring engine may differentiate between a risk regarding a communication about a market outlier if the market on which the outlier trades is closed at the time of the communication. If trading for the market outlier is closed at the time of the communication, the risk may be less as a trade may be less imminent.
Wall crossed—The scoring engine may consider whether the client on the communication or a subject of the communication is a publicly listed company that is trying to raise capital through large stock sales that are pre-arranged to institutional investors before a public announcement of the offering.
Any mention of a restricted list in a response to a communication. A restricted list is a list of securities that a bank's employees may not buy or sell. The scoring engine may consider a mention of the restricted list.
Badge log analysis after or pre-chat? Did employee get off of the desk?—The scoring engine may consider whether the employee on the communication left the trading desk before or after the communication, which may reflect that an employee engaged in a trade or took some other action while away from the employee's desk.
On what medium did the communication take place? Examples of the communications medium may be an employee desk-located device, Turret, which is a specialized telecom system used by financial traders, a voice over IP (VOIP) phone, or a mobile device;
Location of the client, such as place of business.
Internal or external communication—A greater or lesser risk score may be associated with a communication that is internal at the entity vs. a communication that was with one or more persons outside of the entity, such as a client.
If the communication was an internal conversation, did a conversation occur in a private or public setting?
If the communication was external, was it a communication by a current employee with a former employee?
Participant Count—the number of participants in the communication being scored;
Were trade alerts issues around the time of the conversation?
Pre-financial earnings—Was earnings information available to either participant in the communication before the earning information was publicly reported?
Employee Risk History *—May consider previous risk history scores for employee's communications and previous escalations of risk associated with the employee.
Context or History of Interactions between employee and client engaged in communication. *—For example, if the employee and the client are personal friends, the scoring engine may determine that the risk of discussing business-related matters may be less than if the employee and client are not personal friends.
Open source searching of an employee/client *—The scoring engine may analyze what the employee may have been searching to identify information related to the subject of the communication.
Perform a search of publicly available records to determine whether there any non-business connections between the employee and client outside of the entity. *
Employee private/public *—does the employee work on the private side or the public side of the business; if on the private side, does the employee have access to material non-public information (MNPI). This factor may account for the amount of access, if any, the employee has to private/confidential information vs. access to public information.
Seniority—* The seniority of an employee may be considered. A senior employee may be more experienced and careful, but may have greater access to private information.
Job Title of Employee *
Job Description of Employee *
Job Responsibilities of Employee *
Employee regulated status *—The scoring engine may consider whether the employee is allowed to engage in the particular type of communication, such as voice, text, or chat communications, with the client.
Employee Access to Confidential Information *
Previous chats or communication *—The scoring engine may consider whether any previous chats in which the employee engaged mention unauthorized information;
Sentiment Analysis *—an analysis of the employee communications for the emotional tone of the communications. For example, consider whether the reference by the employee to a communication reflects a positive or negative sentiment about a business or just reflects a sentiment of a conversation among friends.
Behavioral Analysis *—Use behavioral science and analytics to identify any clues based on behaviors or actions during past communications of employee with the clients and other clients or internal employees.
Various data points like call data records, corporate numbers, or outliers of calls to known numbers.

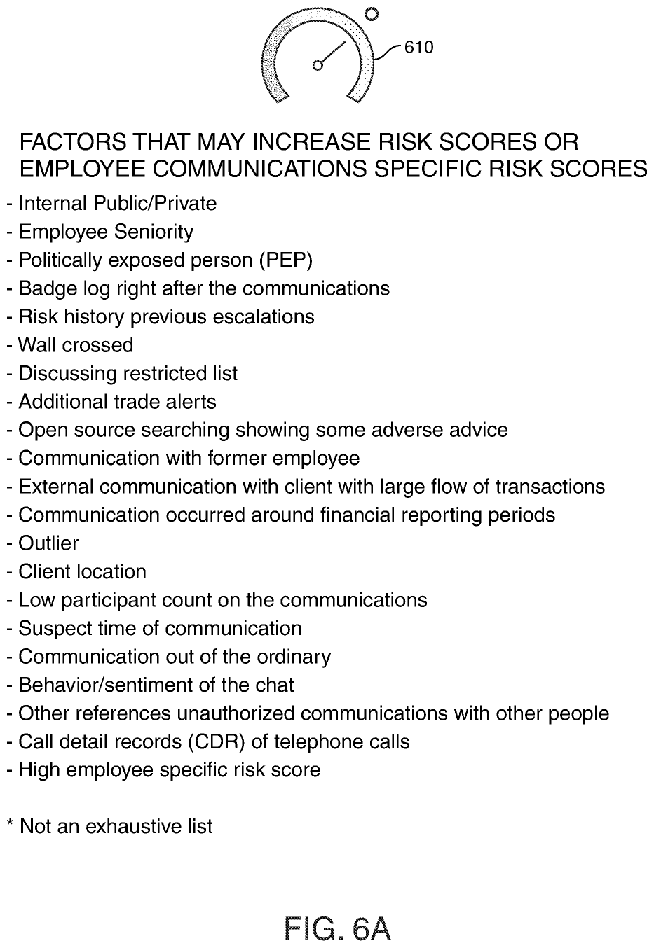

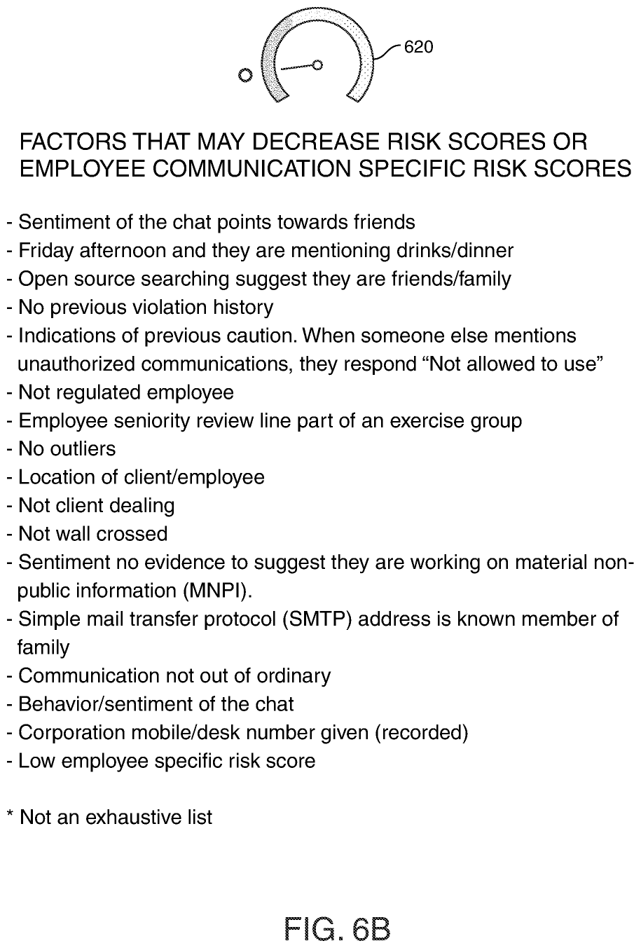

Additional examples of factors that may be considered in determining risk scores are included in FIGS. 6A and 6B.

Risk scores may be increased or decreased based on a factor or a group of factors. FIG. 6A shows a non-exhaustive list of illustrative factors that, if present, may increase communication-specific or employee specific risk scores or both. The higher risk may be reflected on a risk score gauge 610 that may be displayed to an employer or employee. FIG. 6B shows a non-exhaustive list of illustrative factors that may decrease risk scores. The lower risk may be reflected on a risk score gauge 620 that may be displayed to an employer or employee. The factors relied on in calculating risk scores may include one or more of the listed factors in these figures or may include other factors that may not be listed in FIGS. 6A or 6B.

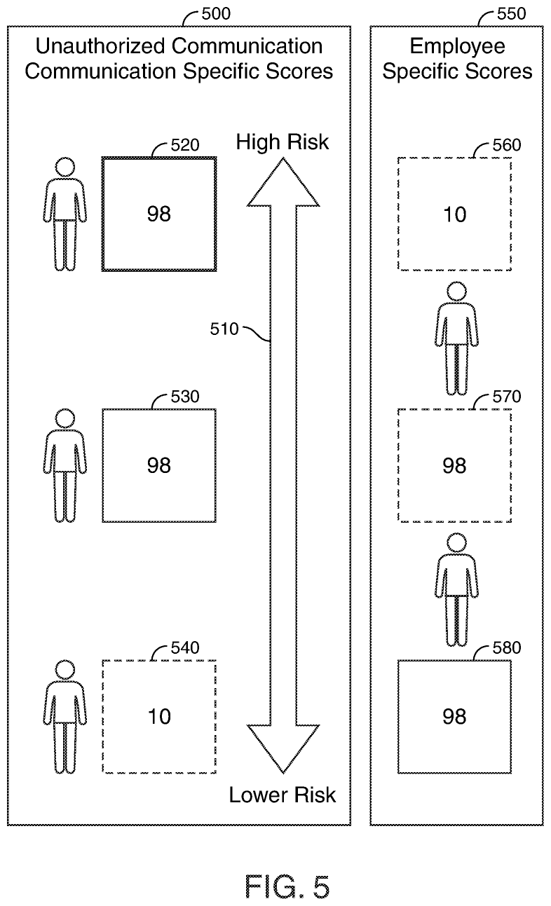

FIG. 5 shows examples where separate communication-specific and employee specific risk scores are both determined for detected references to three unauthorized communications. The examples illustrate the communication-specific risk score 500 and an employee specific risk score 550 may be considered in whether to perform an operation in response to a detection of risk in either risk score 500 or risk score 550. The communication specific and employee risk scores 500, 550 may show a similar level of risk or may vary from one another. Where there are discrepancies in the risk levels identified by the communication-specific risk score 500 and the employee specific risk score 550, a decision by the risk reduction system as to whether to perform an automated operation to reduce risk, and what operation to perform, may be made based on the communication-specific score or may be based on the employee specific score or both.

In a first example illustrated in FIG. 5, the communication-specific score 520 may be high—e.g., a 98—which indicates a high risk on a risk scale 510. However, an employee specific risk score 560 for the communication may be determined to have a low risk, such as a risk of 10 out of 100. This may be, for example, because the employee has proven to be trustworthy. In this example, the risk reduction system may determine that the high risk of the communication-specific risk score 520 necessitates that an operation be performed to mitigate risk. The operation may not be directed against the employee, but it may include, for example, halting a trade. Thus, in the first example, a high risk value of risk score 520 may prevail in causing an operation to be performed to reduce risk despite the low employee specific risk score 560. This may be shown by a solid border around risk score 520 and a dashed border around risk score 560. As the employee specific score is low while the communication-specific score is high, the employee's access to make trades may remain unchanged.

In a second example, the communication-specific score 530 and the employee specific score 570 may be determined to be identical. Given that the scores both have a value of 98, a risk reduction operation may be performed based on the communication-specific score that indicates a high risk. As the communication-specific score and the employee specific score reflect a high risk, the employee's access to make trades may also be halted. If both scores had been low, then no operation may occur.

In a third example, the communication-specific score 540 may be 10, which may indicate a low risk, but the employee specific score 580 with a with a high risk value of 98 is a cause for concern. In this example, the employee specific score 580 may prevail and an operation may be performed in response to the high risk score. An operation may include an employee targeted response that blocks employee access to some or all systems, such as to trading systems, or a cutoff of communications, given that the employee is the main cause for concern rather than the unauthorized communication itself.

Thus, the communication specific and employee specific scores may be used to determine when an operation is to be performed to reduce risk and what operation to perform.

The monitoring and scoring engines may operate in real time or as close to real time as possible.

Monitoring engine may monitor all communications at the entity. In some embodiments, monitoring engine may not monitor all communications at the entity. This may be due to a size of the entity or due to limitations on resources. Much of the risk may still be detected by focusing on monitoring communications of a subset of employees whose employee specific risk scores reflect a history of causing a high risk to the entity, while monitoring less frequently employees with historically lower employee specific risk scores. This more limited monitoring may allow more resources to be available to address riskier behaviors in real time.

Scoring engine may score all detected uses by employees of unauthorized communications channels or may score fewer than all detected uses. Scoring of fewer than all detected uses of unauthorized communications channels may occur, for example, by scoring a randomized sampling of the detected uses.

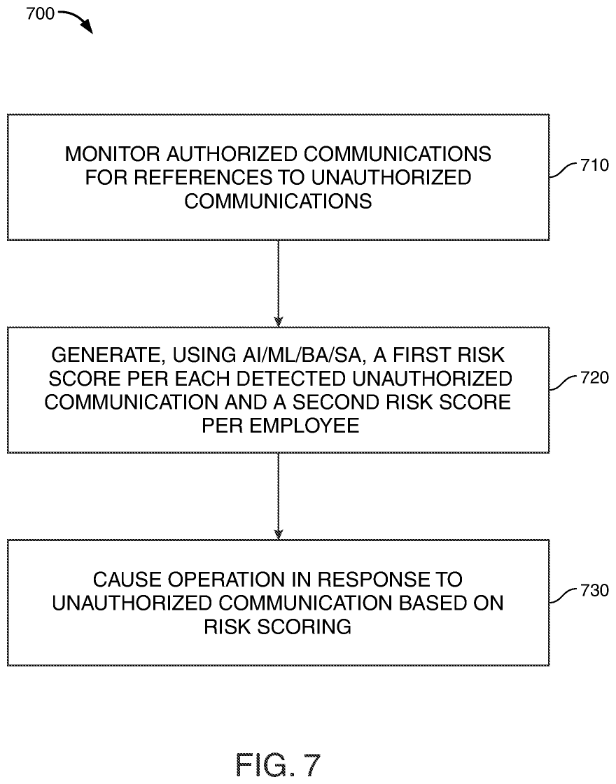

FIG. 7 shows an illustrative example of a flow chart 700 of a method that an entity may implement to reduce risks and potential fines associated with possible use of unauthorized communications by employees. At step 710, authorized communications may be monitored for references to unauthorized communications between employees of an entity and other parties, such as clients of the entity. This step may use AI/ML to determine indicators of references to unauthorized communications. At step 720, a first risk score may be generated for detected unauthorized communications. A second risk score may also be generated for the detected unauthorized communication that is based on a risk associated with the employee who engaged in the communication. AI/ML, BA, and SA may be used to determine the risk scores. At step 730, an operation may be initiated in response to a detection of an unauthorized communication that is risk scored to be at a certain level or within a certain range of levels.

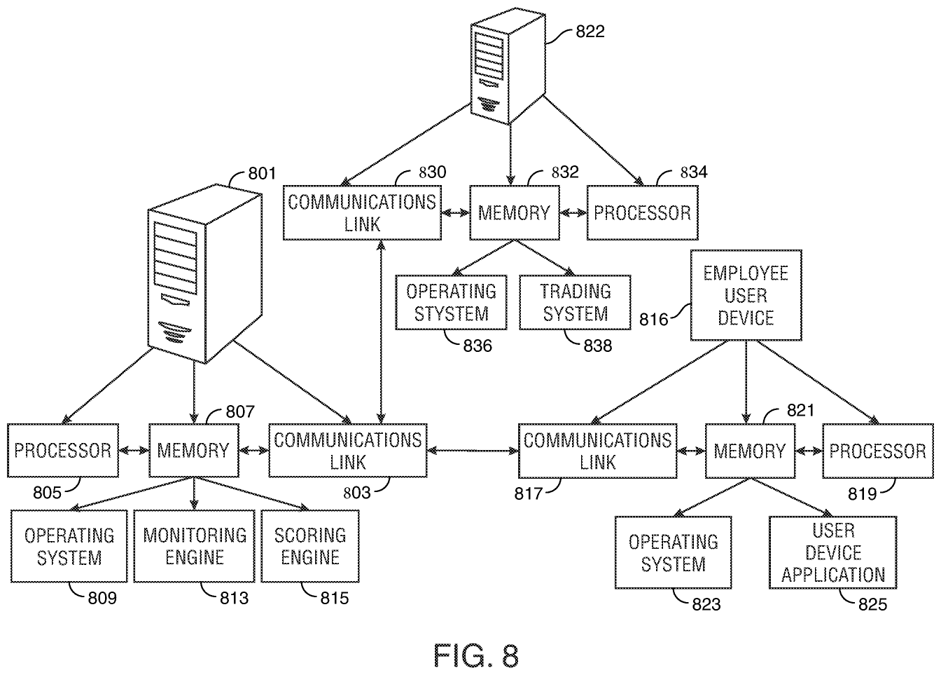

FIG. 8 shows an illustrative system in accordance with principles of the disclosure. The system may include a first server 801 for monitoring, by the entity, communications that are required to be monitored and risk scoring, a device 816 at the entity for use by the employee for business-related communications, and a second server 822 for performing trading of financial instruments.

Server 801 may include a server communications link 803, a server processor/processors 805, and a server non-transitory memory 807, as well as other components.

Device 816 may include a non-transitory memory 821, a device communications link 817, and a processor 819, as well as other components.

Second server 822 may include a communications link 830, a non-transitory memory 832, a processor 834, an operating system 836, and a trading system 838.

The server non-transitory memory 807 may include a server operating system 809, a monitoring engine 813, and a scoring engine 815 for scoring unauthorized communications by employees, as well as other data and programs.

The server communications link 803 may communicate with an employee user device 816, such as a desktop or laptop computer or a tablet, (as well as other servers/computers, not shown), through communications link 817. The server communications link 803 may communicate with second server 822 through (as well as other servers/computers, not shown) the communications link 830.

Communications link 803 may communicate with the employee user device 816 via communications link 817 to send alerts to the employee related to detection of risky unauthorized communications. Communications link 793 may communicate with second server 822 to halt trades arranged by an employee that has engaged in risky unauthorized communications. There may also be a direct link between communications links 817 and 822 for the employee to conduct trades when permitted.

By using this system, computer program product, or method, risk scoring of the use of unauthorized communications channels that are detected by monitoring authorized communications channels may be achieved and used to cause operations to be performed to reduce risks to an entity that may be caused by an employee.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, apparatuses, and computer program products may implement scoring of communications that use unauthorized communications channels to enable performance of operations to reduce risk to an entity caused by such communications. Persons skilled in the art will appreciate that the present invention can be practiced by other than the described embodiments, which are presented for purposes of illustration rather than of limitation.

What is claimed is:

1. An artificial intelligence (AI) communications risk reduction system for reducing risk to an entity caused by employees of the entity communicating with one or more other parties using unauthorized communications channels, wherein the system comprises:
a monitoring engine that is configured to monitor one or more authorized communications channels and detect references in communications that use the one or more authorized communications channels to uses of unauthorized communications channels by the employees to communicate with the one or more other parties; and
a scoring engine that is configured to use AI/ML to generate, for each of a plurality of the communications that includes one of the detected references:
a first risk score based on one or more first risk-related factors that are related to the respective one of the communications and are identified by the scoring engine for risk scoring of unauthorized communications channels usage; and
a second risk score for the respective one of the communications that is based on one or more second risk-related factors that relate to employee specific information that is specific to a respective one of the employees who engaged in the respective one of the communications;
wherein the authorized communications channels comprise a first group of communications channels that the entity allows the employees to use for entity-related communications, and the unauthorized communications channels comprise a second group of communications channels that the entity does not authorize the employees to use for entity-related communications; and
wherein the system is configured to cause an operation to be performed to reduce risk when the first risk score or the second risk score is at a predetermined risk level or is within a predetermined risk score range.

2. The system of claim 1, wherein the scoring engine is configured to further use behavioral analytics to generate the first risk score or the second risk score.

3. The system of claim 1, wherein the scoring engine is configured to further use sentiment analysis to generate the first risk score or the second risk score.

4. The system of claim 1, wherein the one or more first risk-related factors on which the first risk score is based comprise one or more of a type of one of the unauthorized communications channels that has been referenced, a first risk history at the entity for the type of the unauthorized communications channels, a previous escalation for the type of the unauthorized communications channels, a participant count for the one or more other parties to the respective one of the communications, or information regarding the one or more other parties.

5. The system of claim 1, wherein one or both of the first risk score and the second risk score that are generated are further based on one or more of a time of day, a day of a week, month or year, or a reporting cycle for the entity.

6. The system of claim 1, wherein the one or more second risk-related factors that relate to the employee specific information comprises one or more of a job title, a job description, job responsibilities, a job location, years of service, seniority, a regulated status of the respective employee at the entity, employee access to confidential information, or a history of interactions by the respective employee with the one or more other parties.

7. The system of claim 1, wherein the first risk score is further based on the employee specific information or the second risk score is further based on the first risk score.

8. The system of claim 1, wherein one or more of the unauthorized communications channels comprises one of an unauthorized email account, a personal employee telephone, a text, a chat service, an instant messaging service, or social media.

9. The system of claim 1, wherein the operation comprises one or more of sending an alert to the respective employee or to a manager of the employee, halting a trade that was arranged by the respective employee, blocking further communications by the respective employee, or sending a reminder to the respective employee about a policy of the entity regarding use of unauthorized communications channels.

10. The system of claim 1, wherein the entity is a financial institution, and the risk comprises a regulatory risk.

11. The system of claim 1, wherein the first risk score or the second risk score is generated as follows:
$$0 \leq \sum {W}_{i} {f}_{i} \leq 100 for i = 0 to n$$
where fᵢ is the value of the iₜₕ risk factor that represents the risk determined for the risk factor, Wᵢ is the weight given to the risk factor, Wᵢfᵢ is the value of the weight Wᵢ multiplied by the value fᵢ, and ΣWᵢfᵢ for i=0 ton is the value of the respective risk score being generated.

12. A risk reduction computer program product for using artificial intelligence (AI)/machine learning (ML) to reduce risk to an entity caused by employees of the entity communicating with one or more other parties using unauthorized communications channels, wherein the computer program product comprises executable instructions that, when executed by a processor on a first computer system:
monitor one or more authorized communications channels using and detect references in communications that use the one or more authorized communications channels to uses of unauthorized communications channels by the employees to communicate with the one or more other parties;
generate, for each of a plurality of the communications that includes one of the detected references, using AI/ML:
a first risk score for a respective one of the communications based on one or more first risk-related factors that are related to the respective one of the communications and are identified by a scoring engine for risk scoring of unauthorized communications channels usage; and
a second risk score for the respective one of the communications that is based on one or more second risk-related factors that relate to employee specific information that is specific to a respective one of the employees who engaged in the respective one of the communications;
causing an operation to be performed to reduce risk when the first risk score or the second risk score is at a predetermined risk level or is within a predetermined risk score range;
wherein the authorized communications channels comprise a first group of communications channels that the entity allows the employees to use for entity-related communications, and the unauthorized communications channels comprise a second group of communications channels that the entity does not allow the employees to use for entity-related communications.

13. The computer program product of claim 12, wherein the first risk score or the second risk score is generated using one or both of behavioral analytics or sentiment analysis.

14. The computer program product of claim 12, wherein the one or more first risk-related factors on which the first risk score is based comprise one or more of a type of one of the unauthorized communications channels that has been referenced, a first risk history at the entity for the type of the unauthorized communications channels, a previous escalation for the type of the unauthorized communications channels, a participant count for the one or more other parties to the respective one of the communications, or information regarding the one or more other parties.

15. The computer program product of claim 12, wherein one or more of the first risk score and the second risk score that are generated are further based on one or more of a time of day, a day of a week, month or year, or a reporting cycle for the entity.

16. The computer program product of claim 12, wherein the one or more second risk-related factors that relate to the employee specific information comprises one or more of a job title, a job description, job responsibilities, a job location, years of service, seniority, a regulated status of the respective employee at the entity, employee access to confidential information, or a history of interactions by the respective employee with the one or more other parties.

17. The computer program product of claim 12, wherein one or more of the unauthorized communications channels comprises one of an unauthorized email account, a personal employee telephone, a text, a chat service, an instant messaging service, or social media.

18. The computer program product of claim 12, wherein the operation comprises one or more of sending an alert to the respective employee or to a manager of the employee, halting a trade that was arranged by the respective employee, blocking further communications by the respective employee, or sending a reminder to the respective employee about a policy of the entity regarding use of unauthorized communications channels.

19. The computer program product of claim 12, wherein the first risk score or the second risk score is generated as follows:
$$0 \leq \sum {W}_{i} {f}_{i} \leq 100 for i = 0 to n$$
where fᵢ is the value of the iₜₕ risk factor that represents the risk determined for the risk factor, Wᵢ is the weight given to the risk factor, Wᵢfᵢ is the value of the weight Wᵢ multiplied by the value fᵢ, and ΣWᵢfᵢ for i=0 to n is the value of the respective risk score being generated.

20. An artificial intelligence (AI) communications risk reduction system for reducing risk to an entity caused by employees of the entity communicating with one or more other parties using unauthorized communications channels, wherein:
an input for receiving electronic alerts to detections of references by employees in communications over authorized communications channels to uses of one or more of unauthorized communications channels by the employees to communicate with the one or more other parties; and
a scoring engine that is configured to use AI/machine learning to generate, for each of a plurality of the communications that include one of the detected references:
a first risk score for a respective one of the communications based on one or more first risk-related factors that are related to the respective one of the communications and are identified by the scoring engine for risk scoring of unauthorized communications channels usage; and
a second risk score for the respective one of the communications that is based on one or more second risk-related factors that related to employee specific information that is specific to a respective one of the employees who engaged in the respective one of the communications;
wherein the authorized communications channels comprise a first group of communications channels that the entity allows the employees to use for entity-related communications, and the unauthorized communications channels comprise a second group of communications channels that the entity does not allow the employees to use for entity-related communications; and
wherein the system is configured to cause an operation to be performed to reduce risk when the first risk score or the second risk score is at a predetermined risk level or is within a predetermined risk score range.
